(19) United States
(12) Patent Application Publication
(10) Pub. No.: US 2006/0042222 A1
(43) Pub. Date: Mar. 2, 2006

(54) Method for the production of elongated elements afor jewels

(76) Inventor: Pietro Rancan, Trissino (IT)

Correspondence Address: LEFFERT JAY & POLGLAZE, P.A., P.O. BOX 581009, MINNEAPOLIS, MN, 55458-1009, US

(21) Appl. No.: 10/533,662

(22) PCT Filed: Mar. 10, 2003
(86) PCT No.: PCT/IT03/00144

§ 371 Date: May 3, 2005

(51) Int. Cl. F16G 13/00

(52) U.S. Cl. 59/80

(57) ABSTRACT

Method for the production of elongated elements (1; 9; 13; 15) for making jewels, comprising the steps of: (a) providing a longitudinally hollow covering (2; 10) and a core (3; 7; 111, 112) placed within the covering (2; 10) and extending at crosswise opposite longitudinal edges of the covering (2; 10) and by the core (3; 7; 111, 112) to a pressing carried out at said longitudinal edges of the covering (2; 10).

The present invention relates to a method for the production of elongated elements for making jewels, such as for example necklaces, bracelets, anklelaces, earring pendants and general jewellery products. In particular, the present invention relates to a method for the production of elongated elements of the so-called “omega” type.

In the jewel production, elements with elongated shape are very used for making for example necklace chokers, bracelets, anklelaces, earring pendants and so on.

As it is well known to the skilled in the art, the word “omega” usually denotes a type of elongated element obtained by inserting some small rings of precious metal onto a core or by helically wounding a metal strap or the like about the core. Such core is usually made of a metallic fabric or by a single body such as for example a wire or a lamina.

A particolar type of “omega” elongated elements provides a convex cross-section, almond-like shaped for example, having two opposite faces which can be machined differently or even be made of different materials. This latter type of “omega” elements allows then obtaining so-called “double-face” or “reversible” manufacts, that is wherein the two opposite faces are both apt to be placed in sight.

The traditional production methods of this type of “omega” elongated elements have some drawbacks. The main drawback lies in that the end manufacts have a remarkable weight, since the body constituting the core thereof must occupy almost the whole inner cavity of the small rings or of the spiral-wound body and this then affects in great percentage the total weight of the end product. This core geometry arises from the need of adequately supporting the outer ring or spiral covering in the pressing step, that is shaping step, of the resulting elongated element. Such pressing is carried out by acting on the whole outer surface of the elongated element so that the covering assumes the wished end shape.

The production modes just described, apart from increasing—as already said—the weight and thus the cost of the end product, further set limits indirectly also to the possible sizes of the obtainable jewels, for example to the width of the necklaces. Furthermore, the obtained jewels, still due to said weight problems, may result uncomfortable to wear on. Moreover, upon increasing the sizes of the cross-section of the end elongated element, the inner core necessarily tends to become stiffer, in this way compromising the correct wearability of the jewel which cannot be able to follow softly the body shapes. For example, in case of a chocker, the resulting necklace tends to remain lifted with respect to the neck or breast.

U.S. 2002/0038556 discloses a method of the above kind for producing a double-face chain of the “Omega” type, wherein rings are inserted onto a central core and the whole structure undergoes a pressing action performed along the entire transversal extension of the structure itself.

For the elongated elements of the “omega” type which provide a covering of the spiral-wound type, a production method is known to the state of art consisting in winding the covering itself about a steel plug which is extracted at the end of the production process, thus obtaining an end elongated element constituted by a hollow helix. In order to prevent such spiral from lengthening under traction, a so-called “kern” is then inserted inside thereof which is welded at the longitudinal ends of the helix itself. Such kern may consist for example in a wire or a chain. Nevertheless, such kern is absolutely not suitable to confer to the end product an adequate resistance to bending or twisting. This translates into a possible misalignment of the helix turns which irremediably penalizes the jewel aesthetic aspect.

The technical problem underlying the present invention is then to provide a method for the production of elongated elements, in particular of the “omega” type, which allows obviating to the drawbacks mentioned above by referring to the known art and in particular which allows obtaining an optimum compromise between weight of the end manufactured article and the mechanical resistance thereof.

Such problem is solved by a method for the production of elongated elements according to claim 1.

The present invention relates to elongated elements of any metal, precious or not, suitable for making jewels, such as for example gold, silver, platinum, steel, titanium and so on.

The present invention has some important advantages. The main advantage lies in that the inner core longitudinally fastened to the outer covering provides stability and bending and twisting mechanical resistance to the elongated element even without requiring it to extend to fill-in the whole cross-section of the latter. This allows obtaining then an end elongated element, which, outer sizes being the same, results less heavy, less expensive and has a better and more comfortable wearability. On the other hand, it is possible to make, more easily with respect to the methods of known art, also very wide elongated elements which result mechanically stable

Other advantages, features and application modes of the present invention will be evident from the following detailed description of some embodiments, illustrated by way of example and not for limitative purpose. The figures of the accompanying drawings will be referred to, wherein:

FIGS. 1A and 1B refer each to a corresponding step of a first embodiment of the invention method, showing cross-sectional views of an elongated element during the making thereof;

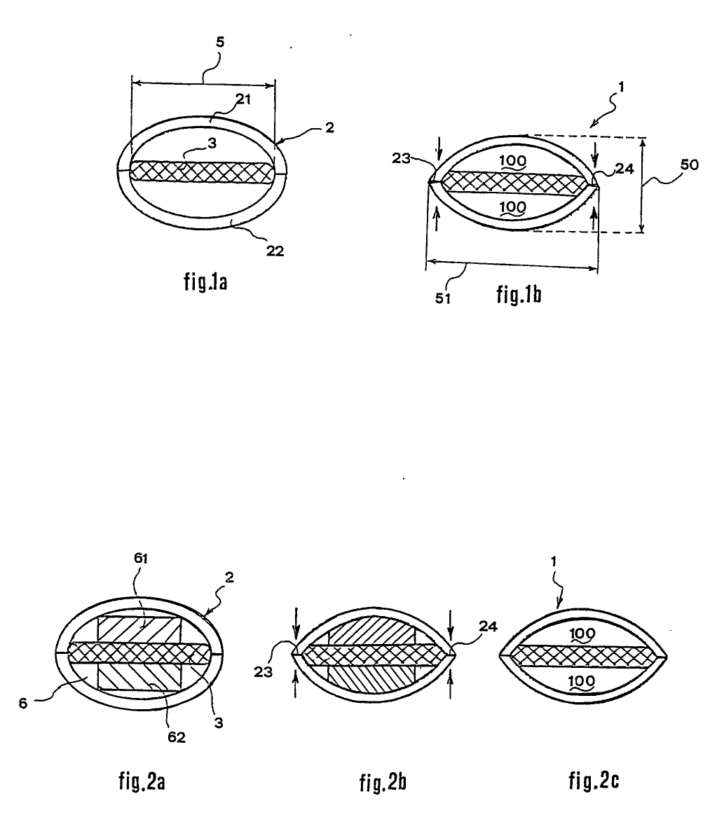

FIGS. 2A to 2C refer each to a corresponding step of a second embodiment of the invention method, showing cross-sectional views of an elongated element during the making thereof;

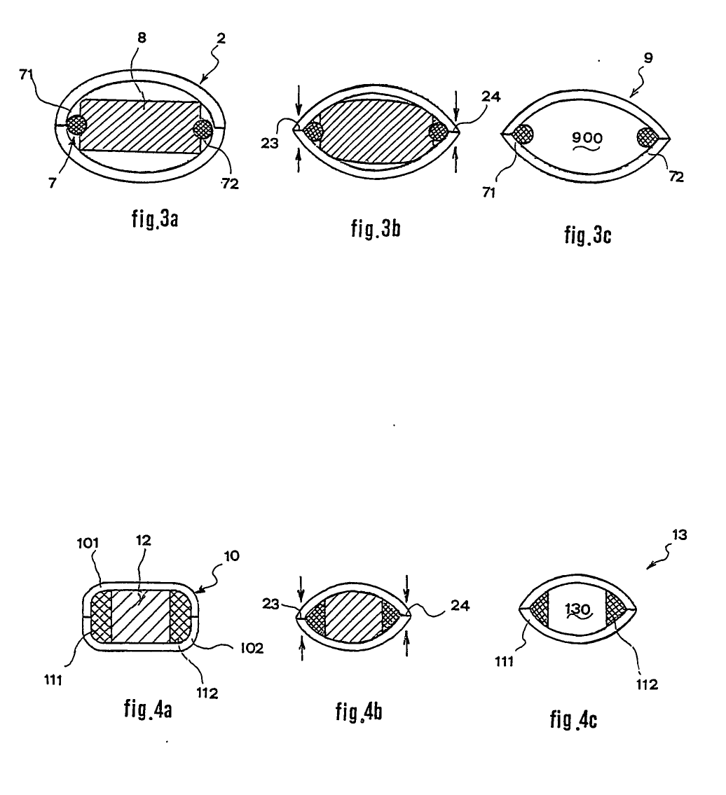

FIGS. 3A and 3B refer each to a corresponding step of a third embodiment of the invention method, showing cross-sectional views of an elongated element during the making thereof;

FIGS. 4A to 4C refer each to a corresponding step of a fourth embodiment of the invention method, showing cross-sectional views of an elongated element during the making thereof;

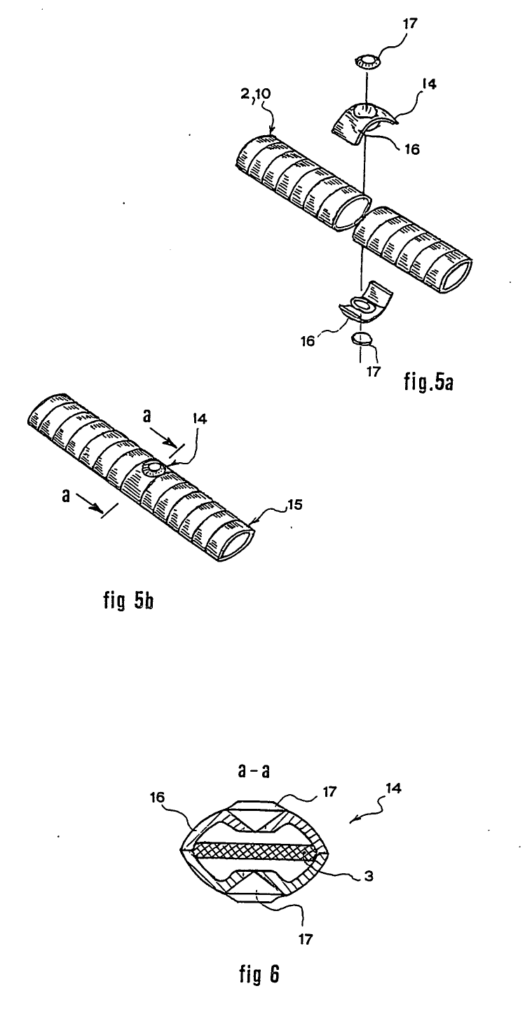

FIGS. 5A and 5B refer both to an elongated element obtained by means of an embodiment variant of the invention method, showing an exploded view and a perspective view thereof, respectively;

FIG. 6 shows a cross-sectional view of a component of the elongated element of FIG. 5A;

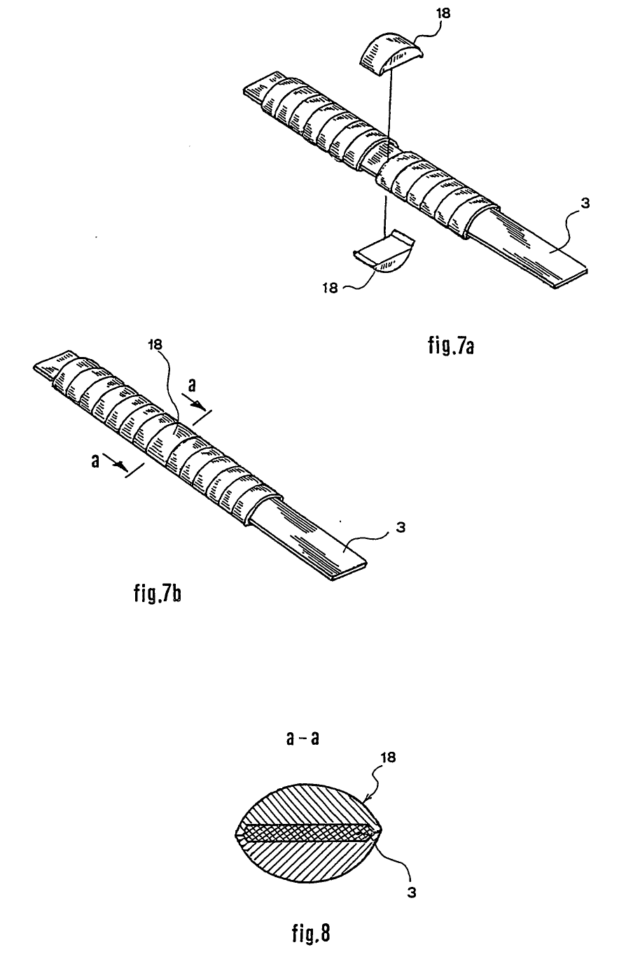

FIGS. 7A and 7B5B refer both to an elongated element obtained by means of another embodiment variant of the invention method, showing an exploded view and a perspective view thereof, respectively;

FIG. 8 shows a cross-sectional view of a component of the elongated element of FIG. 7A;

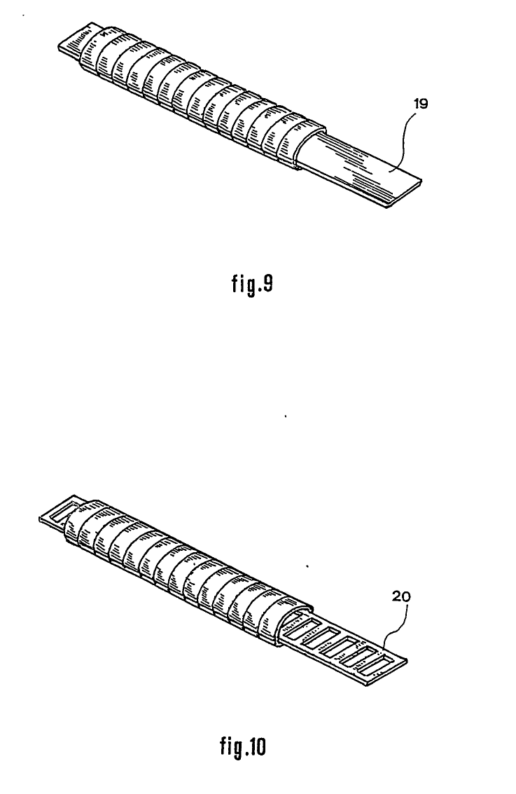

FIG. 9 shows a perspective view of another embodiment of elongated element according to the invention;

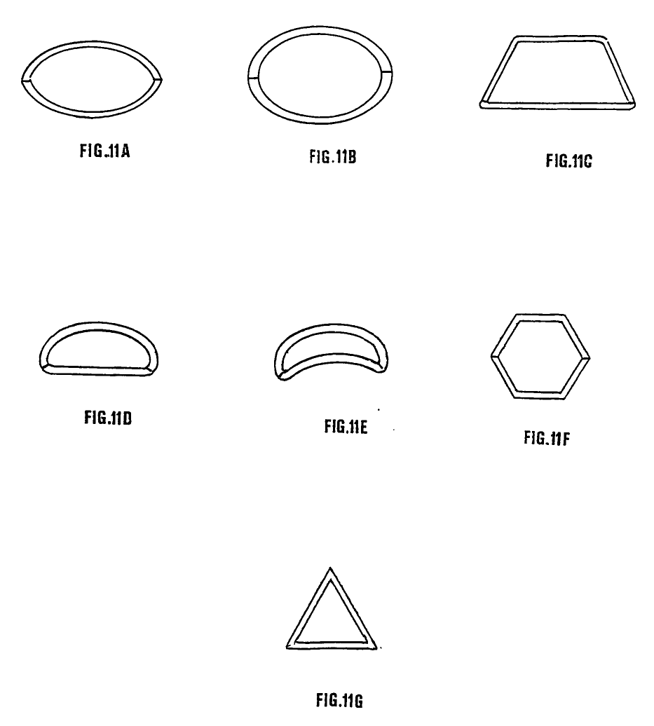

FIG. 10 shows a perspective view of an additional embodiment of elongated element according to the invention; and

FIGS. 11A to 11G show each a cross-sectional view of a possible alternative configuration of the covering of the elongated element obtained with the invention method.

A first embodiment of the method for the production of elongated elements according to the invention is shown in the FIGS. 1A and 1B by referring to a method for obtaining an end elongated element 1 of “omega” type.

In a first step of such method, a covering 2 is provided, which can be of ring type or of the type obtained by substantially helically winding an elongated body such as for example a strap or a wire. The preparation of such covering 2 can be carried out according to known modes and techniques.

By referring to FIG. 1A, the covering 2 initially provides a substantially convex, and substantially elliptical in particular, cross-section, having two opposite faces 21 and 22. The latter can be made of or coated with different materials, for example precious metals of different type, in order to obtain a double-face end jewel having a double wearing possibility.

In a second step of the method a core 3 is provided, which in the present embodiment is a metallic strip of a fabric having a mesh structure of the interlaced-wire type. Still in the present embodiment, the core 3 has a substantially rectangular cross-section.

Embodiment variants can provide that the core 3 consists in a solid body such as for example a foil, also called lamina, or a wire.

The core 3 has a larger cross dimension 5 substantially equal or comparable to the larger cross dimension of the inner longitudinal cavity of the covering 2, that is to the dimension corresponding to the distance between crosswise-opposite longitudinal edges 23 and 24 of the covering itself 2. In this way, as it will be illustrated in greater detail hereinafter, it guarantees the alignment between the rings or the turns of the covering 3 in the best possible way.

At this point, the covering 2 is inserted onto the core 3. Obviously, an embodiment variant immediately evident for the skilled in the art is that, in case of covering 3 of helix-wound type, the elongated body implementing the helix is directly wound on the core 3.

At this point, as schematically shown in FIG. 1B, the structure formed by the covering 2 and by the core 3 is subjected to pressing along the whole longitudinal extension thereof, which pressing is however carried out only at the lateral flanks of the covering 3, that is only at the above-mentioned crosswise-opposite longitudinal edges 23 and 24 of the forming elongated element 1. In this way, the longitudinal edges of the core 3 are squashed between the sides 23 and 24 of the outer covering 2, and in particular “clinched” by the latter, therefore resulting firmly fixed to the latter.

Such step can be carried out for example by means of molding or rolling.

It will be appreciated that the pressing operation just described produces a shaping of the elongated element 1, which in the present case confers a substantially almond-like or eye-like shaped cross section to the latter. Such shaping allows obtaining, on the covering 2, the already mentioned, well distinct two opposite faces 21 and 22. As said above, in this way it is possible obtaining a double-face end elongated element 1 which can provide to obtain substantially different aesthetic effects at said two faces 21 and 22.

Obviously, embodiment variants can provide shapings different for the resulting composite structure. Examples of possible alternative shapings, such as a substantially oval or quadrangular shape or with parallel or slanted sides and so on, are shown in the FIGS. 11A to 11G.

An embodiment variant can also provide, after or before the just described pressing step, an additional shaping step.

Therefore, the faces 21 and 22 can be conventionally machined by diamonding, polishing, glazing processes and so on, possibly in a different manner one with respect to the other.

At this point, the end elongated element can be sectioned into a desired number of longitudinal segments, each with size suitable for making a desired jewel or a portion thereof.

All the machinings required by the specific aim can be then carried out on some of these segments.

For example, each segment can be calendered with contemporary fornace annealing, to confer a desired longitudinal profile thereto. In the specific case of a necklace such step can be carried out so as to confer to the composite structure an arcuate longitudinal profile necessary for a correct and optimum wearability. Subsequently, the application of a closure device can be provided.

It will be appreciated at this point that the pressing step, or clinching step, above described allows the core 3 to guarantee both the perfect alignment between the rings or the turns of the covering 2 and a good mechanical resistance to bending, twisting and traction of the end manufact.

Furthermore, also the wearability of the elongated element results greatly improved, thanks to the greater flexibility of the element itself and to the above mentioned perfect alignment of the rings or the turns even when the element is subjected to twisting or bending.

In particular, experimental tests have shown that the method of the invention allows making necklaces with width greater than 15 mm which result mechanically stable and easy to wear as just illustrated.

Furthermore, experimental tests have shown that the total weight of the end elongated element can result, dimensions and outer geometry and thickness of the covering being equal, 30% to 70% lower with respect to the one of an “omega” elongated element made with the known methods, with evident advantages in cost for the end user.

At last, experimental tests have shown that with the invention method it is possible to increase the ratio between height 50 and width 51 of the cross section, currently not greater than 0.3, up to a value of 0.5 and even above. That is, very convex shapes, and with a very appreciated aesthetic effect, can be obtained, with a negligible increase in weight, considering that the inner volume is almost wholly empty.

It will be also appreciated that both above and below the core 3 a lightening compartment 100 remains defined which not only involves indeed a great lightening of the total structure of the “omega” elongated element 1, but, in the present embodiment, provides also a space to set precious stones onto the elongated element itself, as it will be illustrated also hereinafter by referring to embodiment variants of the method.

It will be appreciated that the present invention is suitable for several embodiments and variants alternative the one described sofar which allow obtaining the same advantages, some of which are briefly illustrated hereinafter by referring to the single aspects which differentiate it from what has been described sofar. Therefore, equal components will be designated with the same reference numeral already used.

In the FIGS. 2A to 2C a second embodiment of the invention method is illustrated, particularly suitable for making “omega” elongated elements with great width, and in particular necklaces wide more than 6-8 mm.

Based upon such second embodiment, as shown by FIG. 2A a covering 2 is provided analogous to the one of the first embodiment, the inner longitudinal cavity of which is wholly or almost wholly occupied by a composite core. The latter is formed by a first portion substantially analogous to the one already above described, and designated then with the same reference numeral 3, and by a second portion 6 made of two parts 61 and 62 and made of a material soluble in chemical bath, such as for example brass, copper, tombac alloy, aluminium, mild steel, a polymeric material or a combination thereof.

In particular, the overall structure of the core is sandwich-like, since the first portion 3 is placed between the two parts 61 and 62 of the second portion.

In FIG. 2A, the two parts 61 and 62 of the composite core have been schematically represented and only by way of example as formed each in a single body with substantially rectangular cross section, but they can have any shaping both longitudinal and transversal. In particular, such parts 61 and 62 can consist in a metallic fabric with mesh structure formed, for example, by interlaced thin wires of copper or brass.

In a subsequent method step, the structure formed by the composite core and by the covering 2 can be subjected to an annealing process.

Therefore, as schematically shown in FIG. 2B, in an additional method step the composite structure formed by the core and by the covering 2 is subjected to pressing at the side longitudinal edges 23 and 24 of the covering 2 itself and, in case, to an additional shaping step, according to modes wholly analogous to what already illustrated by referring to the first embodiment of the invention.

The second portion 6 of the core provides, during the pressing step and possibly the additional shaping step, a structural support to the covering 2, by preventing the latter from breaking or deforming in an undesired way. In particular, in this step the composite core as a whole accompanies with the plastic deformation thereof the shape change of the covering 2, by providing an adequate mechanical support and at the same time by guaranteeing the perfect alignment between rings or adjacent turns of the covering itself.

It will be appreciated that the mechanical properties of the composite core are very well suitable to make complex shapes of the cross section of the end elongated element.

At this point, the second portion 6 of the composite core is eliminated by means of a solvent material. The kind of solvent material depends of course upon the specific manufacturing of the core portion 6, that is upon the specific support material(s) which it is made of. For example, if the support material is chosen in a group containing brass, copper and tombac alloy, the solvent material will contain nitric acid. On the contrary, if the support material contains aluminium, the solvent material will contain caustic soda. Again, if the support material contains mild steel, the solvent material will contain chloridric acid. At last, if the support material is a polymeric material, the solvent material will be a solution liquid.

At the end of such step, an end elongated element 1, shown in FIG. 2C, will be then obtained, wholly analogous to the one of the first embodiment, but which could have greater width compared to the latter, and in particular width also greater than 15 mm.

In the FIGS. 3A to 3C a third embodiment of the invention method is illustrated, particularly suitable for making elongated elements of “omega” type too.

In this embodiment the method provides that a covering analogous to the one of the preceding embodiments be provided and designated with 2 also in this case. A composite core is housed inside the covering 2, comprising in this case a first portion 7 made of two parts 71 and 72, placed at longitudinal edges of the covering 2, and a second central portion 8 substantially parallelepiped-shaped and made of a material soluble in chemical bath, similarly to what already described by referring to the second portion of the composite core of the second embodiment.

The two parts 71 and 72 of the first portion of the composite core consist each in a filiform element or in a fabric strip with mesh structure having, in the present example, a substantally circular cross section.

The “soluble” central portion 8 of the composite core supports the two parts 71 and 72 of the first portion 7 by keeping them adhering to the outer covering ends during the different method steps.

Also in this case, the structure formed by the composite core and by the covering 2 is subjected to a longitudinal pressing step similar to the one of the preceding embodiments and apt to lock the two parts 71 and 72 with the covering 2.

Then, in a subsequent method step, the second soluble portion 8 of the composite core is eliminated, according to modes analogous to the ones of the second embodiment. An end elongated element 9, shown in FIG. 3C, is then obtained, having on the outside an aspect wholly similar to the one of the preceding embodiments and having inside a support core formed by the two parts 71 and 72 clinched to the covering 2, which elongated element 9 has mechanical properties analogous to those already illustrated by referring to the preceding embodiments.

Also in this case, the core 7 leaves a lightening empty central compartment, here designated with 900, inside the structure of the elongated element 9 which is suitable for setting precious stones on the elongated element itself.

In the FIGS. 4A to 4C a fourth embodiment of the invention method is illustrated, also in this case applicable to the making of an elongated element of “omega” type.

By firstly referring to FIG. 4A, in a first step of such method a covering 10 is provided with construction similar to the one of the preceding embodiments, but which has initially a substantially rectangular-shaped cross section with rounded angles instead of an ellipse-like section. Also in this case, the covering 10 has two opposite faces, here designated with 101 and 102, and it is then suitable for making double-face jewels.

Within the covering 10 a composite core is housed which occupies the whole longitudinal cavity defined by the covering 10. The composite core comprises in particular a first portion made of two parts 111 and 112 which occupy the side regions of the cavity defined by the covering 10, following the profile thereof, and a substantially parallelepiped-shaped second central portion 12 made of a material soluble in chemical bath, similarly to what described by referring to the second portion of the composite core of the second embodiment.

In the present example, the two parts 111 and 112 of the first portion of the composite core consist each of a fabric strip with mesh structure.

Also in this case, as shown in FIG. 4B, the structure formed by the composite core and by the covering 10 is subjected to a longitudinal pressing step similar to the one of the preceding embodiments and apt to lock the two parts 111 and 112 with the covering 10 itself. Such pressing step involves in this case a substantial deformation of the two parts 111 and 112 of the composite core.

Then, in a subsequent method step the second soluble portion 12 of the composite core is eliminated, according to modes similar to those of the second embodiment. An end elongated element 13 is then obtained having, on the outside, an aspect wholly similar to the one of the preceding embodiments and having inside a support core formed by the two parts 111 and 112 clinched to the covering 10, which elongated element 13 has mechanical properties similar to those already illustrated by referring to the preceding embodiments.

Also in this case, the core 111, 112 leaves a lightening empty central compartment, here designated with 130, inside the structure of the elongated element 13 which is suitable for setting precious stones on the elongated element itself.

In the FIGS. 5A, 5B and 6 a variant of the invention method is illustrated, applicable to the making of an elongated element of “omega” type with ring covering in association with any above described embodiment of the method.

According to this variant, after the pressing step carried out at side longitudinal edges of the covering 2 or 10—and after the possible elimination of the soluble portion of the inner core—it is possible to take out one or more rings which constitute the covering itself and replace them with ornamental members 14 of any kind. An end elongated element 15 is then obtained, shown in FIG. 5B, having one or more ornamental elements 14 alternating with the rings of the covering 2 or 10.

In the FIGS. 5A and 5B, the inner core of the elongated element 15 has not been represented since this can be any one of the types described in the preceding embodiments.

In the example here considered, one or more ornamental elements 14, shown in exploded view in FIG. 5A and in cross-sectional view in FIG. 6, comprises a shaped body 16 and two precious stones 17 set in specific seats obtained on opposite parts of the shaped body 16 itself. In order to allow replacing a ring of the covering, the shaped body 16 can be made of two parts, as shown in FIG. 5A.

It will be appreciated that said setting is made possible thanks to the compartment(s) left empty, in all the embodiments above described, by the inner core of the end elongated element, as already mentioned previously. By only way of example, in FIG. 6 one has referred to the flat core 3 of the first embodiment.

With the known art methods such setting would be impracticable unless increasing the thickness of the covering until wholly housing the setting, obviously to the detriment of the weight of the end manufact, which indeed increases in proportion to thickness.

In the FIGS. 7A, 7B and 8 another embodiment of the invention method is illustrated, this too applicable to make an elongated element of “omega” type with ring covering in association to any of the embodiments above described of the method.

Unlike the preceding variant, in this case the ornamental element(s) replacing one or some rings of the covering 2 or 10 directly consist each in a stone 18 shaped so as to reproduce the outer shape of the rings themselves. Also in this case, by simply way of example in FIG. 8 one has referred to the flat core 3 of the first embodiment of the invention method.

By then referring to the FIGS. 9 and 10, these represent each an additional variant for making the inner core of the end elongated element, which in FIG. 9 consists in a compact solid body 19, a foil in particular, instead of a fabric strip, and in FIG. 10 in a solid perforated body 20.

As far as the materials used in the invention method are concerned, it will be appreciated that both the covering and the core—either under the form of fabric, wire or foil—can be constituted by precious or non-precious metals and/or by plastic or composite materials.

At last, it will be clear at this point that the present invention also provides an elongated element for making jewels, and in particular an elongated element of “omega” type as described sofar.

The present invention has been sofar described by referring to preferred embodiments. It is to be meant that other embodiments underlying the same inventive concept can exist, all however comprised within the protective scope of the herebelow reported claims.

1. A method for the production of elongated elements for making jewels, comprising the steps of:
providing a longitudinally hollow covering of the elongated element;
providing an inner core of the elongated element, placed inside said covering and extending at least in correspondence of transversally-opposite longitudinal edges of the covering itself; and
subjecting the structure formed by said covering and by said core to a pressing carried out at said longitudinal edges of said covering,
wherein said pressing step is carried out only at said longitudinal edges and is such as to make said inner core fixed with said covering at said longitudinal edges, and
wherein the relative dimensions of said core and of said covering are such that a lightening compartment remains defined therebetween after said pressing step.

2-40. (canceled)

41. The method according to claim 1, wherein said compartment is apt to allow setting a stone through said covering.

42. The method according to claim 1, wherein said core extends crosswise between said opposed longitudinal edges of said covering and wherein from each part of said core a lightening compartment remains defined after said pressing step.

43. The method according to claim 42, wherein each of said compartments is apt to allow setting a stone.

44. The method according to claim 1, wherein said covering comprises an elongated body substantially helically wound about said core.

45. The method according to claim 1, wherein said covering comprises a plurality of adjacent rings inserted on said core.

46. The method according to claim 45, comprising, after said pressing step, a step of replacing at least one of said rings with an ornamental member.

47. The method according to claim 46, wherein said ornamental member carries a set stone.

48. The method according to claim 46, wherein said ornamental member consists in a shaped stone.

49. The method according to claim 1, wherein said covering, before said pressing step, has a substantially elliptical cross section.

50. The method according to claim 1, wherein said covering, before said pressing step, has a substantially rectangular-shaped cross section with rounded angles.

51. The method according to claim 1, wherein said covering has a substantially convex cross section.

52. The method according to claim 1, wherein said covering has two opposite faces and said method comprises a step wherein said faces are machined differently one with respect to the other.

53. The method according to claim 1, wherein said covering has two opposite faces and said method comprises a step wherein said faces are made of and/or coated with precious metals of different kinds.

54. The method according to claim 1, wherein said core has a cross dimension substantially equal or comparable to the inner cross dimension of said hollow covering corresponding to the distance between said crosswise-opposed longitudinal edges.

55. The method according to claim 54, wherein said core is substantially flat.

56. The method according to claim 55, wherein said core comprises a foil.

57. The method according to claim 1, wherein said core comprises a perforated element.

58. The method according to claim 1, wherein said core comprises at least a mesh structure with interlaced wires.

59. The method according to claim 1, wherein said core is made of two parts each arranged at one of said longitudinal edges of said covering.

60. The method according to claim 59, wherein each of said parts is a filiform element.

61. The method according to claim 59, wherein each of said parts is under the form of strip.

62. The method according to claim 1, wherein said core comprises a first portion soluble in a respective solvent and a second portion insoluble in said solvent, which second portion is made fixed to said covering in said pressing step and wherein the method provides a step of eliminating said first soluble portion subsequently to said pressing step.

63. The method according to claim 62, wherein said first soluble portion is made of two parts.

64. The method according to claim 63, wherein said two parts of said first soluble portion are placed on opposite sides of said second portion according to a substantially sandwich-like configuration.

65. The method according to claim 62, wherein said second portion of said core is made of two parts.

66. The method according to claim 65, wherein said two parts of said second portion are placed each at one of said opposite longitudinal edges of said covering and wherein said first soluble portion is placed between said two parts of said second portion.

67. The method according to claim 66, wherein said first soluble portion of said core supports said two parts of said second portion so as to keep them adhering to said longitudinal opposed edges of said covering during said pressing step.

68. The method according to claim 62, wherein said first soluble portion of said core is made of a material chosen in a group comprising brass, copper and tombac alloy and said solvent comprises nitric acid.

69. The method according to claim 62, wherein said first soluble portion of said core comprises aluminium and said solvent comprises caustic soda.

70. The method according to claim 62, wherein said first soluble portion of said core comprises mild steel and said solvent comprises chloridric acid.

71. The method according to claim 62, wherein said first soluble portion of said core comprises a polymeric material and said solvent is a solution liquid.

72. The method according to claim 1, wherein said pressing step is apt to produce the clinching of said core between said opposite longitudinal edges of said covering.

73. The method according to claim 1, wherein said pressing step comprises, in turn, a molding or rolling step.

74. The method according to claim 1, wherein said pressing step is apt to confer to said covering a substantially almond-like shaped cross section.

75. The method according to claim 1, wherein said pressing step is apt to confer a substantial deformation to said core at said opposite longitudinal edges of said covering.

76. The method according to claim 1, comprising an additional step of setting a stone in said covering subsequently to said pressing step.

77. The method according to claim 1, comprising a step of inserting, after said pressing step, an ornamental member onto the elongated element.

78. The method according to claim 1, which provides making a double-face final elongated element.

79. The method according to claim 1, which provides making a final elongated element of “omega” type.
